(19) United States
(12) Patent Application Publication
(10) Pub. No.: US 2026/0204434 A1
(43) Pub. Date: Jul. 16, 2026

(54) ROTATING ELEMENT CONTAINING A LIQUID METAL LINER AND HAVING A PLURALITY OF VALVES

(71) Applicant: General Fusion Inc., Richmond (CA)

(72) Inventors: Michel Georges Laberge, West Vancouver (CA); James Hastings Wilkie, Port Coquitlam (CA); Raphael Segas, Vancouver (CA); Joerg Zimmermann, Vancouver (CA); Alexander Douglas Mossman, Vancouver (CA); David Franklin Plant, Vancouver (CA); Victoria Suponitsky, Coquitlam (CA); Jean-Sebastien Dick, Vancouver (CA); Christopher Russell Esterer, Vancouver (CA); Lon William McIlwraith, Kamloops (CA)

(21) Appl. No.: 19/135,036

(22) PCT Filed: Jan. 10, 2024
(86) PCT No.: PCT/CA2024/050023

§ 371 Date: Jun. 2, 2025

Related U.S. Application Data
(60) Provisional application No. 63/479,799, filed on Jan. 13, 2023.

(51) Int. Cl. G21B 1/11

(52) U.S. Cl. CPC G21B 1/11

(57) ABSTRACT

An apparatus is configured to be rotated within a vacuum vessel of a plasma compression system. The apparatus includes a substantially cylindrical outer wall configured to rotate about a longitudinal symmetry axis. The outer wall includes an outer surface, an inner surface at least partially bounding an inner volume of the apparatus, and a plurality of channels extending through the outer wall. The inner volume is configured to contain a liquid medium. The apparatus further includes a plurality of valves affixed to the outer wall and in fluid communication with the plurality of channels. The plurality of valves is configured to selectively control pressurized gas flow from outside the outer surface, through the plurality of channels, into the inner volume.

### FIELD

This application relates generally to systems and methods for applying pressure to a rotating liquid metal liner to compress a plasma encircled by the liquid metal liner.

### BACKGROUND

Unless otherwise indicated herein, the materials described in this section are not prior art to the claims in this application and are not admitted to being prior art by inclusion in this section.

General Fusion's Magnetized Target Fusion (MTF) technology uses liquid metal to compress a magnetized hydrogen isotope (e.g., deuterium-tritium) plasma to initiate nuclear fusion of the hydrogen isotopes, forming helium or tritium and generating an energetic neutron or proton, respectively. The energetic particles are absorbed in and heat the liquid metal, and the heat can be extracted, thereby providing a source of energy. The plasma is positioned within a substantially cylindrical vortex cavity formed by rotating the liquid metal within a rotating cylinder within a fusion containment vessel such that centrifugal force moves the liquid metal against the walls of the rotating cylinder, forming a liquid metal liner surrounding the vortex cavity. The liquid metal liner is compressed by externally applied pressure to collapse in the radial and axial directions, thereby imploding the vortex cavity and creating a spheroidal collapsing cavity. The plasma contained therein is compressed as the liquid metal liner collapses. During this compression, fusion conditions are achieved within the plasma, and as the fusion reaction occurs, heat is released into the liquid metal liner. This heat energy can be removed by circulating the heated liquid metal through a heat exchanger.

Previous systems compressed the liquid metal liner radially using a mechanical compression system to apply pressure to the liquid metal liner. For example, the LINUS system developed in the U.S. Naval Research Laboratory in the 1970s utilized compression pistons that rotated around the liquid metal liner along with the reaction vessel. For another example, U.S. Pat. No. 10,002,680 B2 (developed by General Fusion Inc.) discloses a system in which a rotating liquid metal liner is formed by spinning a liquid metal into a vortex cavity within a pressure vessel, a plasma is positioned in the center cavity of the vortex, and implosion of the liquid metal liner and compression of the plasma in the cavity is driven by acoustic pressure waves generated by pistons moving within bores which are fixedly mounted to an outer wall of the pressure vessel, the pistons striking anvils positioned radially around the pressure vessel. For still another example, U.S. Pat. No. 10,798,808 (developed by General Fusion Inc.) discloses a rotor that circulates the liquid medium to create the liquid liner, which is then collapsed by compression drivers positioned radially outside of and fixedly mounted to the pressure vessel. The liquid medium partially fills the compression driver such that the liquid medium spans a gap between the rotor and the non-rotating pressure vessel. In further developments by General Fusion Inc. (see, e.g., Int'l Publ. No. WO 2022/155725), the liner implosion and plasma compression are driven by the transfer of pressurized gas from compression drivers positioned radially around the pressure vessel into implosion drivers located in the rotating core inside the vessel and in communication with the liner. The liner initially starts as a cylindrical vortex cavity, and during compression, the liquid metal liner is dynamically shaped as it radially converges, the inner shape of the liner is deliberately evolved to a spherical shape to maximize plasma compression and heating the plasma to fusion conditions.

### SUMMARY

In certain implementations, an apparatus is configured to be rotated within a vacuum vessel of a plasma compression system. The apparatus comprises a substantially cylindrical outer wall configured to rotate about a longitudinal symmetry axis. The outer wall comprises an outer surface, an inner surface at least partially bounding an inner volume of the apparatus, and a plurality of channels extending through the outer wall. The inner volume is configured to contain a liquid medium. The apparatus further comprises a plurality of valves affixed to the outer wall and in fluid communication with the plurality of channels. The plurality of valves is configured to selectively control pressurized gas flow from outside the outer surface, through the plurality of channels, into the inner volume.

In certain implementations, a plasma compression system is configured to receive and contain a plasma within a volume at least partially bounded by a circulating metallic liquid medium and to controllably compress the liquid medium around the plasma, thereby reducing the volume and compressing the plasma. The system comprises a plasma containment vessel, a plurality of pressurized gas sources fixedly attached to the vessel, and an apparatus within the vessel. The apparatus is configured to contain the metallic liquid medium within an inner volume at least partially bounded by the apparatus and to rotate within the vessel about a longitudinal symmetry axis of the apparatus. The apparatus comprises a plurality of valves configured to receive pressurized gas from the plurality of pressurized gas sources. The plurality of valves is configured to be controllably actuated to apply the pressurized gas directly to the metallic liquid medium within the inner volume to compress the metallic liquid medium in a predetermined pattern.

### BRIEF DESCRIPTION OF THE DRAWINGS

The drawings are provided to illustrate example implementations described herein and are not intended to limit the scope of the disclosure. Sizes and relative positions of apparatuses in the drawings are not necessarily drawn to scale. For example, the shapes of various apparatuses and angles are not drawn to scale, and some of these apparatuses are arbitrarily enlarged and positioned to improve drawing legibility. Throughout the drawings, reference numbers may be re-used to indicate correspondence between referenced apparatuses.

FIGS. 1A and 1B schematically illustrate a cross-sectional side view and a partial cross-sectional view, respectively, of a plasma compression system in accordance with certain implementations described herein.

FIGS. 2A-2C schematically illustrate an example apparatus in accordance with certain implementations described herein. FIG. 2A is a perspective view of an azimuthal arc segment of the apparatus extending about halfway around the longitudinal symmetry axis of the apparatus. FIG. 2B is a perspective view of a smaller azimuthal arc segment of the apparatus shown in FIG. 2A. FIG. 2C is a cross-sectional view of an azimuthal arc segment of the apparatus in a plane perpendicular to the longitudinal symmetry axis. FIG. 2D is another cross-sectional view of an azimuthal arc segment of another example apparatus in a plane perpendicular to the longitudinal symmetry axis, showing various additional features.

FIG. 3A schematically illustrates a partially transparent perspective view of an example valve in accordance with certain implementations described herein.

FIG. 3B schematically illustrates a partially transparent perspective view of another example valve in accordance with certain implementations described herein.

FIGS. 4A-4C schematically illustrate an exploded perspective view, a side view of the closed state, and a side view of an open state, respectively, of the example valve of FIG. 3B.

FIG. 4D schematically illustrates a cross-sectional view of a portion of the apparatus with a plurality of the example valves of FIG. 3B.

FIGS. 5A-5D schematically illustrates cross-sectional views of the example valve of FIG. 3B in a plurality of states in accordance with certain implementations described herein.

FIG. 6 is a sequence of simulation images schematically illustrating a cross-sectional view of the liquid liner at various moments during the steady state phase, compression phase, and rebound phase in accordance with certain implementations described herein.

FIGS. 7A and 7B schematically illustrate cross-sectional views of two example tools configured to controllably adjust a valve affixed to the outer wall in accordance with certain implementations described herein.

### DETAILED DESCRIPTION

In contrast to previous systems which collapse the liquid liner using pusher pistons within a rotating core, certain implementations described herein utilize direct gas pressure on the liquid liner to collapse the liquid liner and to compress the plasma surrounded by the liquid liner. Previous rotating cores having pusher pistons utilize a fill level of approximately 150% of the cavity volume to function appropriately. This fill level determines the amount of compression energy to be applied to achieve a predetermined compression time, with higher fill levels needing higher compression energies. Certain implementations described herein can reduce the fill level (e.g., to about 30% of the cavity volume) and can be operated using a reduced compression energy, as compared to a pusher-piston-based system, for the same compression time, resulting in smaller and faster compression systems. By using direct pressure, as compared to pusher-piston-based systems, certain implementations provide simplicity (e.g., reduced complexity) and reduced angular momentum of the rotating core.

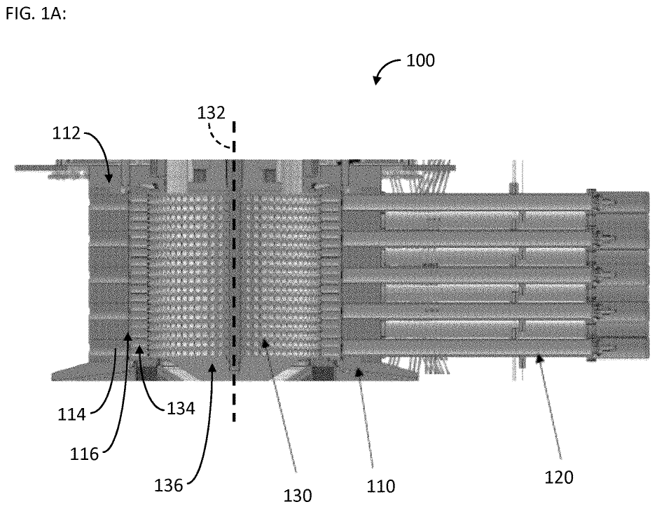

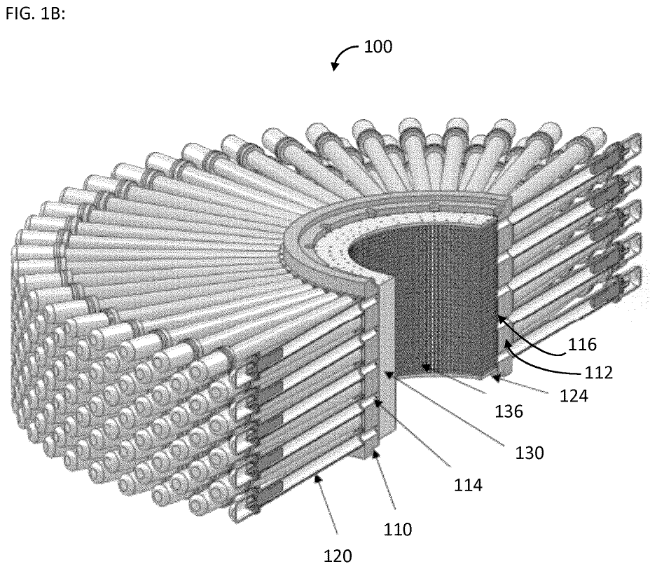

FIGS. 1A and 1B schematically illustrate a cross-sectional side view and a partial cross-sectional view, respectively, of a plasma compression system 100 in accordance with certain implementations described herein. The system 100 comprises a plasma containment vessel 110, a plurality of pressurized gas sources 120 fixedly attached to the vessel 110, and a rotating apparatus 130 (e.g., a rotating element such as a rotating core or rotor) within the vessel 110. The apparatus 130 is configured to contain a liquid liner (not shown in FIGS. 1A and 1B) and to rotate within the vessel 110 about a longitudinal symmetry axis 132 of the apparatus 130. The apparatus 130 comprises a plurality of valves 134 configured to receive pressurized gas from the plurality of pressurized gas sources 120, each valve 134 of the plurality of valves 134 configured to be controllably actuated to apply the pressurized gas directly to the liquid liner within an inner volume 136 at least partially bounded by the apparatus 130 to compress the liquid liner in a predetermined pattern.

As schematically illustrated by FIGS. 1A and 1B, the vessel 110 comprises an outer wall 112 comprising a plurality of ports 114 extending through the outer wall 112 (e.g., from an outer surface to an inner surface of the outer wall 112) and in fluid communication with the plurality of pressurized gas sources 120. The pressurized gas sources 120 can be configured to provide pressurized gas (e.g., pressurized helium) via the ports 114 to a gap volume 116 between the inner surface of the outer wall 112 and the apparatus 130. For example, the pressurized gas sources 120 can each comprise a compression driver having a driver bore in fluid communication with a corresponding port 114 in the outer wall 112 and a driver piston controllably driven to slide within the driver bore to compress (e.g., pressurize) a gas within the driver bore, with the compressed (e.g., pressurized) gas flowing from the driver bore to the gap volume 116. For another example, the pressurized gas sources 120 can each comprise a driver valve (e.g., fast-acting poppet valve) in fluid communication with a corresponding port 114 in the outer wall 112 and configured to be controllably actuated (e.g., opened) to controllably pressurize the gap volume 116 (e.g., by allowing pressurized gas to flow from the port 114 to the gap volume 116). Examples of the ports 114 and the pressurized gas sources 120 that are compatible with certain implementations described herein include, but are not limited to, the ports and compression drivers disclosed by WO 2022/155725. In contrast to the disclosure of WO 2022/155725, in which the compression drivers are utilized with a rotating core comprising a plurality of pusher pistons slidable within a plurality of pusher bores, the pressurized gas sources 120 in accordance with certain implementations described herein are configured to be utilized with the apparatus 130 described herein. Examples of the pressurized gas sources 120 that are compatible with certain implementations described herein include but are not limited to, the valves disclosed in U.S. Provisional Appl. No. 63/268,045, filed on Feb. 15, 2022.

In certain implementations, the inner surface of the outer wall 112 and an outer surface 212 of the apparatus 130 are spaced from one another (e.g., by a distance in a range of 5 millimeters to 50 millimeters) to define the gap volume 116 between the outer wall 112 and the apparatus 130. As schematically illustrated by FIGS. 1A and 1B, the vessel 110 can be substantially cylindrical with a substantially cylindrical outer wall 112 and the apparatus 130 can be substantially cylindrical with a substantially cylindrical outer surface (e.g., that conforms to the curvature of the inner surface of the outer wall 112 of the vessel 110 to define an annular gap volume 116). The vessel 110 can comprise a singular cylinder or can comprise an assembly of a series of stacked rings (e.g., joined by welding or other means such as bolts, to apply axial tension force to the stacked rings), the outer wall 112 having an inner surface that is straight (e.g., cylindrical) or curved (e.g., with a curvature conforming to the curvature of the outer surface of the apparatus 130). In certain implementations, the inner surface of the outer wall 112 of the vessel 110 can have circular steps of varying radial diameters (not shown), and the apparatus 130 can have an outer surface that is stepped with radial diameters conforming to the steps in the inner surface of the outer wall 112 of the vessel 110. Other geometries (e.g., spherical; ovoid) for the vessel 110 and the apparatus 130 are also compatible with certain implementations described herein.

In certain implementations, the apparatus 130 is configured to contain a liquid medium (e.g., liquid metal such as lithium, lead, or a combination thereof). The apparatus 130 is configured to be rotated (e.g., using electric drive motors, steam turbine, or other form of rotational drive) and to circulate the liquid medium. By the resulting centripetal force, the liquid medium flows towards the inner surface of the apparatus 130, forming a liquid liner that surrounds a central cavity within the inner volume 136. The liquid medium is fully contained by the apparatus 130, does not contact the outer wall 112, and is in solid body rotation with the apparatus 130 and with minimal turbulence or cavity surface perturbation. In certain implementations, the liquid medium is wholly within the inner volume 136, while in certain other implementations, a majority of the liquid medium is within the inner volume 136. Plasma can be injected into the central cavity (e.g., using a plasma generator), and the pressurized gas sources 120 can be operated to transmit a pressure pulse across the gap volume 116 to the apparatus 130, which as described more fully below, controls the flow of pressurized gas to push the liquid medium inwards to collapse the liquid liner in a predetermined pattern and to compress the plasma.

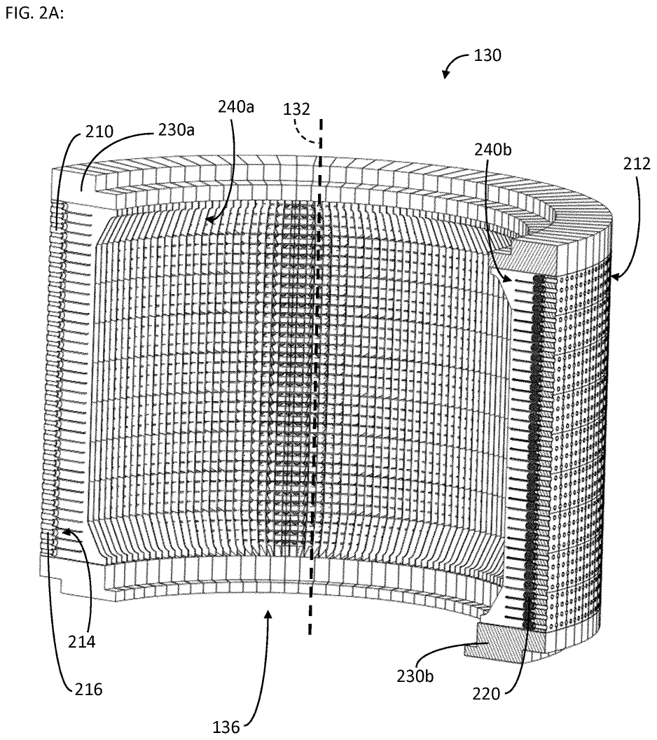

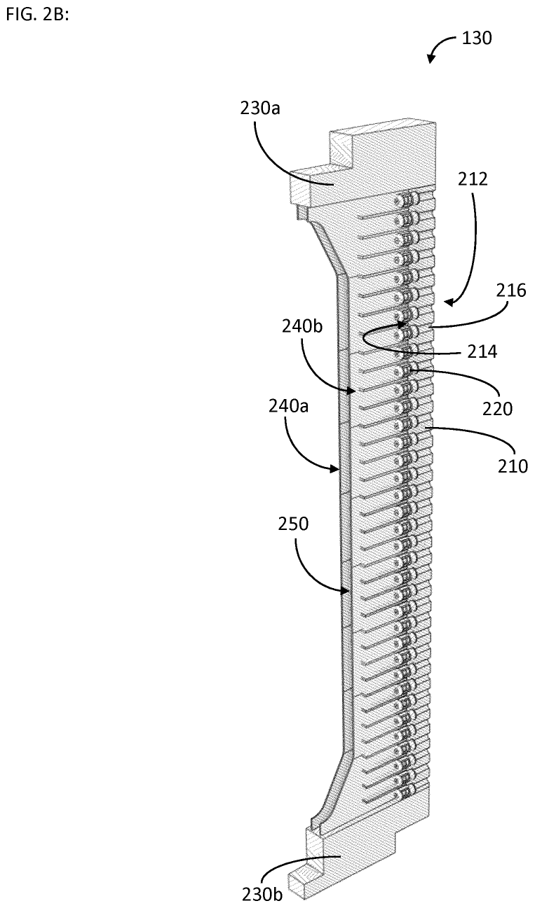

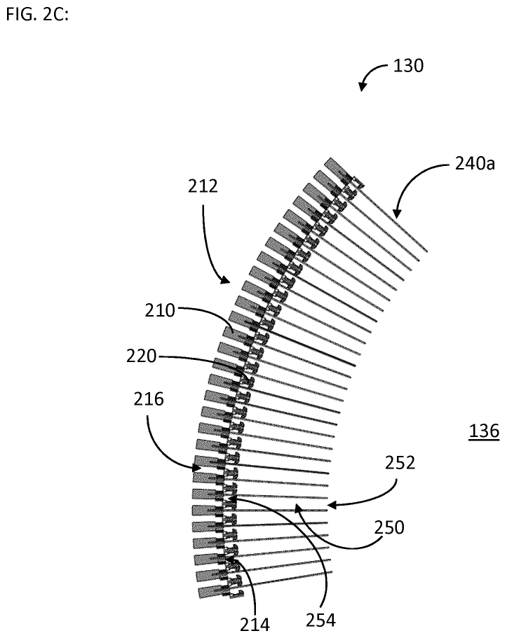

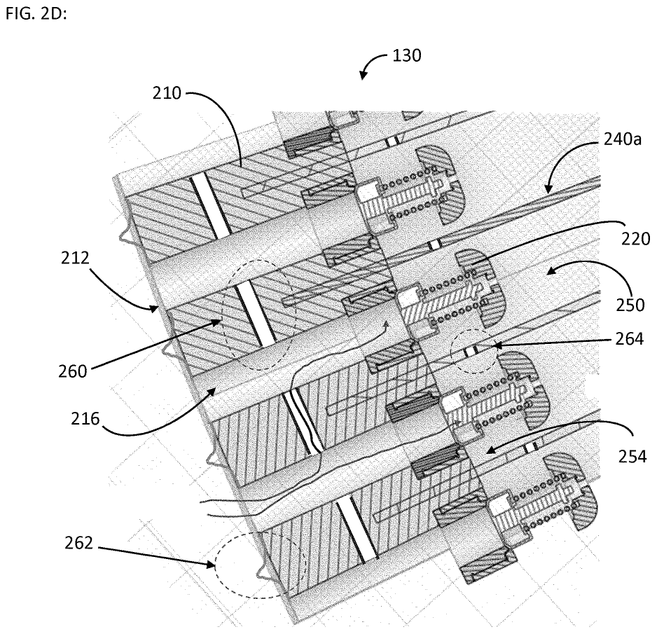

FIGS. 2A-2D schematically illustrate an example apparatus 130 in accordance with certain implementations described herein. FIG. 2A is a perspective view of an azimuthal arc segment of the apparatus 130 extending about halfway around the longitudinal symmetry axis 132 of the apparatus 130. FIG. 2B is a perspective view of a smaller azimuthal arc segment of the apparatus 130 shown in FIG. 2A. FIG. 2C is a cross-sectional view of an azimuthal arc segment of the apparatus 130 in a plane perpendicular to the longitudinal symmetry axis 132. FIG. 2D is another cross-sectional view of an azimuthal arc segment of another example apparatus 130 in a plane perpendicular to the longitudinal symmetry axis 132, showing various additional features.

In certain implementations, the apparatus 130 comprises a unitary unit, while in certain other implementations, the apparatus 130 comprises multiple, shaped sections that are joined together to form the apparatus 130. The construction of the apparatus 130 or its sections can use traditional metal forming and millright techniques or can use metal printing (e.g., additive manufacturing) techniques to create an internal webbed structure that optimizes the topology and stress loading within the apparatus 130.

In certain implementations, as schematically illustrated by FIGS. 2A-2C, the apparatus 130 comprises an outer wall 210 configured to rotate about the longitudinal symmetry axis 132, the outer wall 210 comprising an outer surface 212, an inner surface 214 at least partially bounding an inner volume 136 of the apparatus 130, and a plurality of channels 216 extending through the outer wall 210 (e.g., from the outer surface 212 to the inner surface 214). The apparatus 130 further comprises a plurality of valves 220 affixed to the outer wall 210 and in fluid communication with the plurality of channels 216, each valve 220 of the plurality of valves 220 configured to selectively control pressurized gas flow from outside the outer surface 212, through a corresponding channel 216 of the plurality of channels 216, into the inner volume 136. In certain implementations, the valves 220 are passive (e.g., responsive to pressures or other environmental conditions occurring during operation and the inherent design, materials, and/or dimensions of the device;), while in certain other implementations, the valves 220 are active (e.g., responsive to trigger control signals or other externally applied signals, such as from a sensor, during operation). The example apparatus 130 of FIGS. 2A-2C further comprises first and second endplates 230a,b at opposite ends of the outer wall 210, a plurality of partitions 240 extending radially from the inner surface 214 into the inner volume 136, the plurality of partitions 240 at least partially bounding a plurality of regions 250 within the inner volume 136 between the first and second endplates 230a,b. Each region 250 of the plurality of regions 250 is in fluid communication with a corresponding valve 220 of the plurality of valves 220. Example materials for the outer wall 210, the first and second endplates 230a,b, and the plurality of partitions 240 include, but are not limited to, stainless steel alloy, titanium alloy, and other alloys configured to withstand high pressures and high temperatures and to not react appreciably with the liquid liner and/or the pressurized gas.

In certain implementations, the outer wall 210 is configured to separate the gap volume 116 from the liquid liner within the inner volume 136. As schematically illustrated by FIGS. 2A-2C, the outer wall 210 of the apparatus 130 can be substantially cylindrical having a longitudinal symmetry axis 132 and having a height (e.g., a distance between the two endplates 230a,b) in a range of 1 meter to 10 meters (e.g., in a range of 2.5 meters to 4.5 meters). The outer surface 212 and the inner surface 214 of the outer wall 210 can be substantially cylindrical with an inner radius and an outer radius in a range of 0.5 meter to 5 meters (e.g., in a range of 2 meters to 3.5 meters). The thickness of the outer wall 210 (e.g., difference between the outer radius of the outer surface 212 and the inner radius of the inner surface 214) can be in a range of 0.05 meter to 1 meter (e.g., 0.1 meter to 0.5 meter). Each channel 216 of the plurality of channels 216 can have a longitudinal axis that extends in a substantially radial direction (e.g., substantially perpendicularly relative to the longitudinal symmetry axis 132 of the apparatus 130) from the outer surface 212 to the inner surface 214.

Each channel 216 can have a substantially circular, oval, rectangular, or square cross-sectional shape in a plane substantially perpendicular to the longitudinal axis of the channel 216. In certain implementations, the cross-sectional size of the channel 216 (e.g., width in a range of 30 millimeters to 80 millimeters) is substantially uniform along the longitudinal axis of the channel 216, while in certain other implementations, the cross-sectional size of the channel 216 varies along the longitudinal axis of the channel 216 (e.g., the width of the channel 216 at the outer surface 212 can be larger than the width of the channel 216 at the inner surface 214; the cross-sectional area of the channel 216 can be tapered along the radial direction to maximize volume utilization).

In certain implementations, the first and second endplates 230a,b are substantially annular and substantially perpendicular to and concentric with the longitudinal symmetry axis 132. The first and second endplates 230a,b can be configured to constrain the liquid liner axially (e.g., to keep the liquid liner from flowing out of the top end or bottom end of the apparatus 130) and to allow the liquid liner to rotate in solid body rotation (e.g., without any fluid shear) immediately prior to compression of the liquid liner. In addition, the first and second endplates 230a,b can be configured to provide sealing points for the vacuum boundary and to provide connection points of the apparatus 130 to the rest of the plasma compression system.

In certain implementations, the plurality of partitions 240 parse a portion of the inner volume 136 adjacent to (e.g., at least partially bounded by) the outer wall 210 into a cellular structure (e.g., a substantially rectangular cellular structure as schematically illustrated by FIGS. 2A-2C; a substantially hexagonal or “honeycomb” structure). For example, as schematically illustrated by FIGS. 2A-2C, the plurality of partitions 240 comprises a plurality of axial partitions 240a substantially parallel to and extending along the longitudinal symmetry axis 132 of the apparatus 130 and a plurality of azimuthal partitions 240b substantially perpendicular to and extending around the longitudinal symmetry axis 132. Adjacent (e.g., neighboring) axial partitions 240a can be substantially equally separated from one another and adjacent (e.g., neighboring) azimuthal partitions 240b can be substantially equally separated from one another. The axial partitions 240a and the azimuthal partitions 240b can comprise interlocking planar apparatuses that are substantially perpendicular to one another. The thicknesses of the axial partitions 240a and the azimuthal partitions 240b can be in a range of 8 millimeters to 32 millimeters (e.g., in a range of 10 millimeters to 15 millimeters).

In certain implementations, as schematically illustrated by FIGS. 2A and 2B, the distance that the axial partitions 240a extend into the inner volume 136 from the inner surface 214 is greater than or equal to the distance that the azimuthal partitions 240b extend into the inner volume 136 from the inner surface 214. The distance that the axial partitions 240a extend into the inner volume 136 from the inner surface 214 can vary as a function of position along the axial partitions 240a. For example, as schematically illustrated by FIGS. 2A and 2B, the end portions of the axial partitions 240a (e.g., the portions adjacent to the first and second endplates 230a,b) can extend a larger distance than do the middle portions of the axial partitions 240a (e.g., the portions spaced from the first and second endplates 230a,b). In certain implementations, the distance that the azimuthal partitions 240b extend into the inner volume 136 from the inner surface 214 can be substantially equal around the apparatus 130.

In certain implementations, a region 250 bounded by two adjacent axial partitions 240a and two adjacent azimuthal partitions 240b has a trapezoidal prism (e.g., frustum) shape with a rectangular (e.g., square) front face 252 open to the inner volume 136 and a rectangular (e.g., square) rear face 254 closed by the inner surface 214 and in fluid communication with a corresponding valve 220. Due to the axial partitions 240a and azimuthal partitions 240b extending radially from the inner surface 214 into the inner volume 136, the front face 252 of the region 250 is smaller than the rear face 254 of the region 250. The number of axial partitions 240a around the full inner circumference of the apparatus 130 (e.g., in a range of 50 to 150) and the number of azimuthal partitions 240b between the first and second endplates 230a,b (e.g., in a range of 20 to 80) can be selected such that each channel 216 and each valve 220 are in fluid communication with a corresponding region 250 of the plurality of regions 250. In certain implementations, the plurality of axial partitions 240a and the plurality of azimuthal partitions 240b are configured to provide structural support (e.g., strength) to hold the apparatus 130 together. In certain implementations, the plurality of regions 250 are configured to parse the pressure waves generated by the pressurized gas acting on the liquid liner to enhance the controlled shaping of an inner surface of the liquid liner facing the plasma.

The azimuthal arc segment of FIG. 2B comprises a single axial column of channels 216, valves 220, and regions 250 and the azimuthal arc segment of FIG. 2C comprises a portion of a single azimuthal row (e.g., layer) of channels 216, valves 220, and regions 250 (e.g., the plurality of valves 220 are arranged in an array of axial columns and azimuthal rows). As described more fully herein, the valves 220 within a common azimuthal row can be activated at substantially equal pressures and substantially equal times, while the valves 220 in different azimuthal rows can be activated at different pressures and/or times. As a result of the valve activations for the plurality of valves 220 of the apparatus 130 differing layer-by-layer, the pressurized gas from the valves 220 can have an axially (e.g., vertically) non-uniform pressure and/or timing for pushing directly on the liquid liner and controllably shaping the compression of the liquid liner (e.g., such that the liquid liner compression of the plasma is substantially spherically symmetric).

In certain implementations, to provide a substantially spherically symmetric compression, all the valves 220 on the same azimuthal row (e.g., layer) as one another are activated (e.g., opened) at the same time as one another while the different azimuthal rows of valves 220 are activated at different times from one another. For example, all the valves 220 on the same azimuthal row can be opened within a fraction of a millisecond of one another (e.g., within 250 microseconds of one another).

During early stages of the liner compression process, the expanding volumes of pressurized gas in contact with the liquid liner within adjacent regions 250 can communicate with one another (e.g., via pathways extending through the valve orifices), and the size and state of flow, choked or otherwise, can affect the interactions between these expanding volumes. Various features (e.g., valve orifice size) of the apparatus 130 can be configured to control such communications between adjacent regions 250 to facilitate control of discrete instabilities (e.g., Rayleigh-Taylor instabilities) during the compression of the liquid liner. In certain implementations, the valve orifice size is configured to tailor the communications between adjacent regions 250, while in certain other implementations, other features contribute to tailoring the communications between adjacent regions 250. FIG. 2D schematically illustrates some example features in accordance with certain implementations described herein.

In certain implementations, the apparatus 130 comprises features configured to increase gas flow sharing among the channels 216 on the same azimuthal row (e.g., layer) and to control instabilities resulting from one valve 220 opening slightly faster or slower than the adjacent valves 220 on the same azimuthal row. For example, the apparatus 130 can comprise a plurality of holes 260 extending through the outer wall 210 such that adjacent channels 216 on the same azimuthal row are in fluidic communication with one another. The holes 260 are configured to allow gas to flow from a channel 216 to the two adjacent channels 216 on the same azimuthal row upstream from the valves 220 (e.g., prior to the valves 220 opening; after the valves 220 are opened).

In certain implementations, the apparatus 130 comprises features configured to reduce gas flow sharing among the channels 216 on the same azimuthal row (e.g., layer) via the gap volume 116 between the inner surface of the outer wall 112 of the vessel 110 and the outer surface 212 of the apparatus 130. For example, the apparatus 130 can comprise a plurality of protrusions 262 extending into the gap volume 116 from the outer surface 212 of the outer wall 210. The protrusions 262 can comprise ridges (e.g., fins) extending along the outer surface 212 parallel to the longitudinal symmetry axis 132 of the apparatus 130. The protrusions 262 are configured to reduce gas flow between adjacent channels 216 on the same azimuthal row via the gap volume 116 (e.g., during rotation of the apparatus 130).

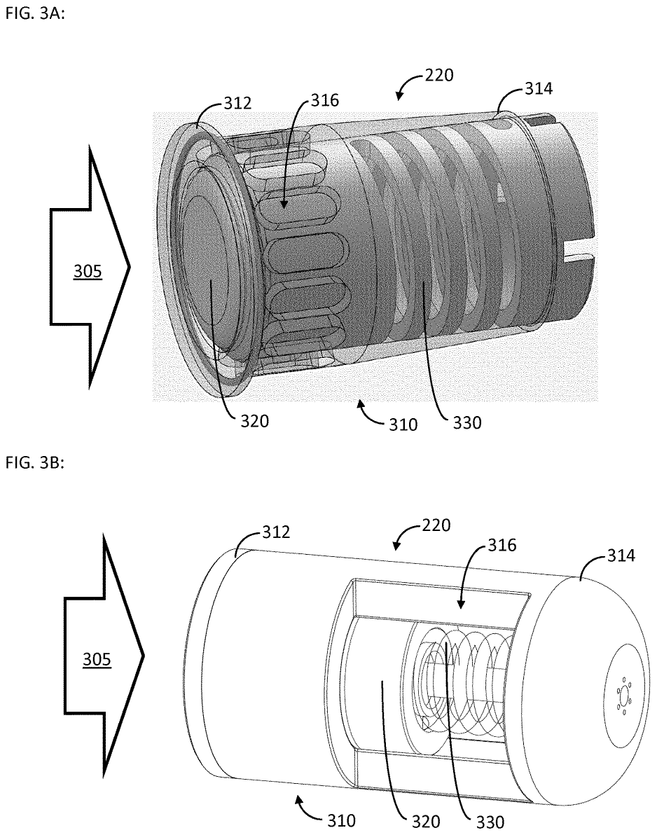

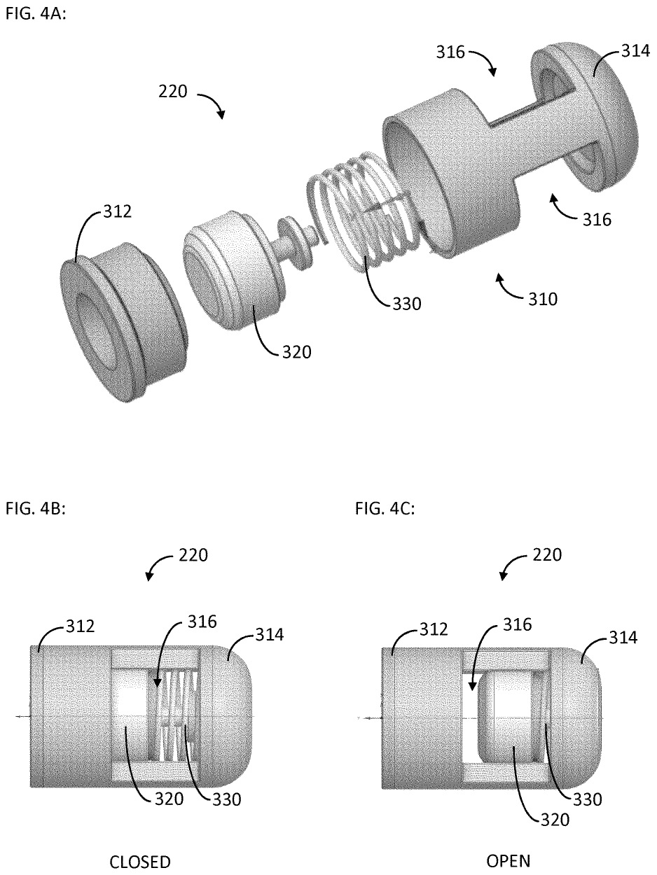

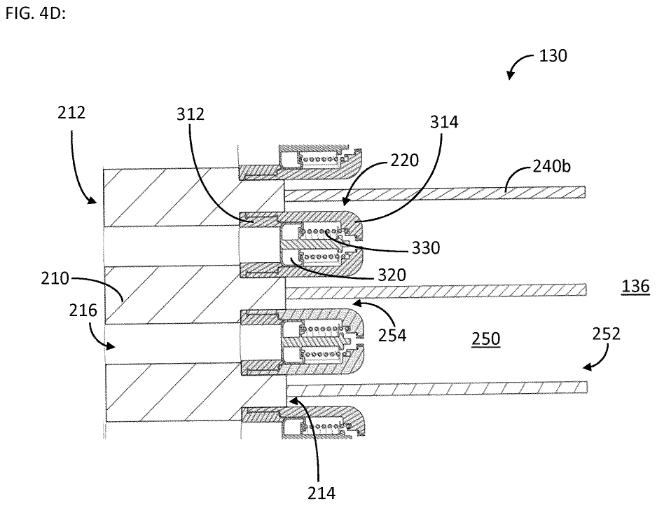

In certain implementations, the apparatus 130 comprises features configured to increase gas flow sharing among the regions 250 (e.g., in proximity to the rear faces 254 of the regions 250) on the same azimuthal row (e.g., layer) and to control instabilities resulting from one valve 220 opening slightly faster or slower than the adjacent valves 220 on the same azimuthal row. For example, the apparatus 130 can comprise a plurality of holes 264 extending through the axial partitions 240a such that adjacent regions 250 on the same azimuthal row are in fluidic communication with one another. The holes 264 are configured to allow the liquid medium to flow from a region 250 to the two adjacent regions 256 on the same azimuthal row downstream from the valves 220 (e.g., prior to the valves 220 opening; after the valves 220 are opened). [0031] FIG. 3A schematically illustrates a partially transparent perspective view of an example valve 220 in accordance with certain implementations described herein. FIG. 3B schematically illustrates a partially transparent perspective view of another example valve 220 in accordance with certain implementations described herein. FIGS. 4A-4C schematically illustrate an exploded perspective view, a side view of the closed state, and a side view of an open state, respectively, of the example valve 220 of FIG. 3B. FIG. 4D schematically illustrates a cross-sectional view (in an axial plane parallel to the longitudinal symmetry axis 132) of a portion of the apparatus 130 with a plurality of the example valves 220 of FIG. 3B.

In certain implementations, the valve 220 comprises a casing 310 having a first portion 312 configured to be in fluid communication with the channel 216, a second portion 314 configured to in fluid communication with the inner volume 136 (e.g., containing the liquid liner), and at least one orifice 316 in fluid communication with the inner volume 136. The valve 220 further comprises a poppet 320 and a spring 330 in mechanical communication with the poppet 320 and the casing 310. The spring 330 is configured to apply a restoring force to the poppet 320 in response to movement of the poppet 320 relative to the casing 310 and the poppet 320 is configured to move relative to the casing 310 in response to pressurized gas 305 from the channel 216 having a gas pressure greater than a predetermined threshold value. For example, a centripetal force applied to the poppet 320 by the rotational motion and/or the restoring force applied to the poppet 320 by the spring 330 can have a predetermined magnitude such that, upon the gas pressure of the pressurized gas 305 within the channel 216 becoming greater than the predetermined threshold pressure (e.g., a threshold pressure that is less than or equal to 45 MPa), the poppet 320 is moved (by the pressure force from the pressurized gas 305 on the poppet 320 counteracting the centripetal force and/or the restoring force from the spring 330 on the poppet 320) to allow flow of the pressurized gas 305 from the channel 216 to the inner volume 136 of the apparatus 130.

In certain implementations, the restoring force of the spring 330 is controllably adjustable (e.g., by an adjustment nut controlling the compression of the spring 330) and the restoring forces of the springs 330 of different valves 220 can differ from one another such that the different valves 220 are controllably activated (e.g., opened) at different moments during the pressurized gas pulse being applied to the gap volume 116 (e.g., the plurality of channels 216). For example, the predetermined threshold pressures at which the valves 220 that are adjacent to the endplates 230a,b are activated can be lower than the predetermined threshold pressures at which the valves 220 that are farther from the endplates 230a,b are activated. For another example, the flow rates of the pressurized gas through the valves 220 that are adjacent to the endplates 230a,b can be greater than the flow rates of the pressurized gas through the valves 220 that are farther from the endplates 230a,b. For still another example, the valves 220 that are adjacent to the endplates 230a,b can be activated earlier than are the valves 220 that are farther from the endplates 230a,b. Upon application of a pressurized gas pulse into the gap volume 116 and the channels 216, as a result of the different predetermined threshold pressures for activation of the different valves 220 at different axial positions, the different flow rates of the different valves 220 at different axial positions, and/or the different activation timings of the different valves 220 at different axial positions, the pressurized gas from the valves 220 pushes directly on the liquid liner and is axially (e.g., vertically) non-uniform such that the liquid liner is shaped by the compression. By adjusting the predetermined threshold pressures, flow rates, and/or timings of the valves 220, the shape of the compressed liquid liner can be controlled (e.g., such that the liquid liner compression of the plasma is substantially spherically symmetric).

In certain implementations, the casing 310 is substantially cylindrical and the first portion 312 (e.g., seal bore) of the casing 310 is configured to form a seal with the channel 216. In certain implementations, the first and second portions 312, 314 are a unitary apparatus, while in certain other implementations, the first and second portions 312, 314 are separate apparatuses that are affixed to one another (e.g., with threads and seals). Example materials for the casing 310, including the first portion 312, the poppet 320, and the spring 330 include, but are not limited to, stainless steel alloy, titanium alloy, and other alloys configured to withstand high pressures and high temperatures and to not react appreciably with the liquid liner and/or the pressurized gas 305. The poppet 320 of certain implementations can comprise a hollow titanium core material, an interface material overlaying the titanium core material, and a shell material overlaying the interface material. The shell material can be configured to seal against a surface of the casing 310 when the poppet 320 is in the closed position. In certain implementations, the poppet 320 and the spring 330 are a unitary apparatus (see, e.g., FIG. 3A), while in certain other implementations, the poppet 320 and the spring 330 are separate apparatuses that are in mechanical communication with one another. In certain implementations, the at least one orifice 316 comprises a plurality of orifices 316 (e.g., 16 orifices as schematically illustrated by FIG. 3A; 2 orifices as schematically illustrated by FIG. 3B). Other numbers of orifices 316 at other positions relative to the casing 310 are also compatible with certain implementations described herein. For the example valve 220 of FIG. 3A, the first portion 312 is configured to be affixed at the outer surface 212 of the outer wall 210 of the apparatus 130 and the casing 310, including the second portion 314, is configured to extend within the channel 216. For the example valve 220 of FIG. 3B, the first portion 312 is configured to be affixed at the inner surface 214 of the outer wall 210 of the apparatus 130 and the casing 310, including the second portion 314, is configured to extend within the region 250. In certain implementations, as schematically illustrated by FIG. 4D, the first portion 312 of the casing 310 is configured to at least partially fit within and to be affixed to the channel 216 (e.g., by a lock ring).

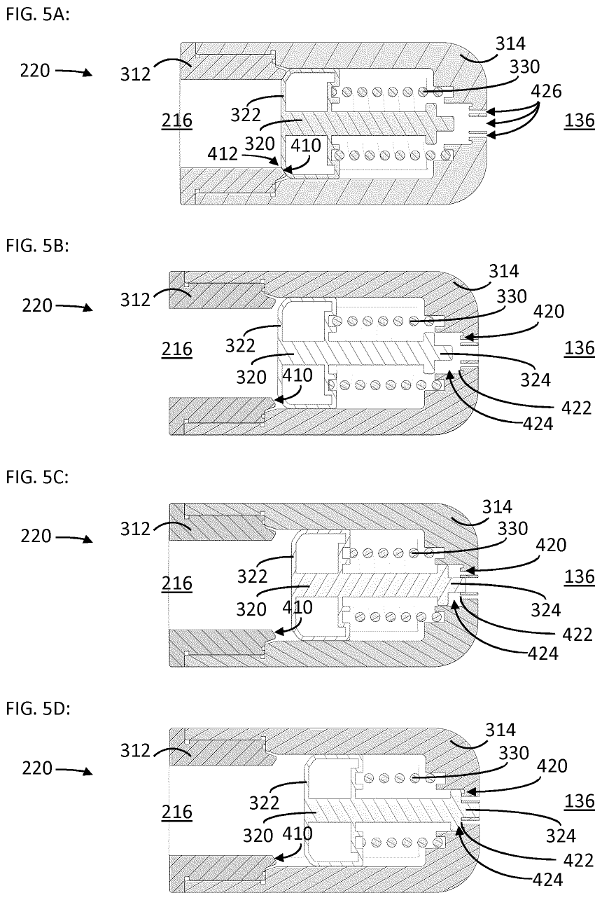

FIGS. 5A-5D schematically illustrate cross-sectional views of the example valve 220 of FIG. 3B in a plurality of states in accordance with certain implementations described herein. For example, as schematically illustrated by FIGS. 4B and 5A, during a steady state phase of operation of the plasma compression system 100, the valve 220 has a closed (e.g., sealed) state in which the poppet 320 is in a sealed position (e.g., a first portion 322 of the poppet 320 is pressed against a surface 410 of the casing 310 by the spring 330, forming a seal 412). For example, in the closed state (e.g., in steady state), the seal 412 is circumferential around an end of the channel 216 such that the seal 412 prevents gas from the channel 216 from reaching the at least one orifice 316 (e.g., to prevent flow of the pressurized gas 305 from the channel 216 through the at least one orifice 316 to the inner volume 136) and such that the seal 412 prevents the liquid liner from flowing radially through the channel 216 (e.g., to prevent flow of the liquid liner from the inner volume 136 through the at least one orifice 316 to the channel 216), thereby retaining the liquid liner within the inner volume 136 of the apparatus 130.

As schematically illustrated by FIGS. 4C and 5B-5D, during a compression phase of operation of the plasma compression system 100, the valve 220 has at least one open state in which the pressurized gas 305 can flow through the at least one orifice 316 (e.g., to compress the liquid liner away from the outer wall 210 inwardly towards the longitudinal symmetry axis 132). For example, in a first open state, as schematically illustrated by FIG. 5B, the pressure of the pressurized gas 305 within the channel 216 has become greater than the predetermined threshold pressure of the valve 220 (e.g., the pressure force from the pressurized gas 305 is greater than the combined restoring force from the spring 330 and the centripetal force from the rotating liquid liner) such that the pressurized gas 305 has moved the poppet 320 away from the surface 410 of the casing 310 (e.g., and compressing the spring 330) to open the valve 220 (e.g., crack the seal 412), allowing the pressurized gas 305 to begin flowing between the poppet 320 and the surface 410 through the at least one orifice 316 (e.g., from the channel 216 to the liquid liner in the inner volume 136).

In a second open state, as schematically illustrated by FIG. 5C, the poppet 320 has moved further from the surface 410 (e.g., further compressing the spring 330), allowing more of the pressurized gas 305 to flow from the channel 216 into the inner volume 136 of the apparatus 130. In certain implementations, the valve 220 comprises a hydraulic brake 420 configured to reduce the speed of the poppet 320 towards the end of the range of motion of the poppet 320 (e.g., to prevent the poppet 320 from impacting into an end stop with damaging force). For example, as shown in FIGS. 5B-5D, a second portion 324 of the poppet 320 can have a shape configured to, with a corresponding portion 422 of the casing 310, at least partially bound a region 424 in fluid communication (e.g., through one or more holes 426 through the casing 310) with the inner volume 136, the region 424 containing liquid metal and having a volume that becomes smaller as the poppet 320 moves further from the sealed position. By capturing some of the liquid metal within the region 424 and forcing the liquid metal through the restrictive holes 426, the poppet 320 and the casing 310 can brake movement of the poppet 320 away from the sealed position. In certain other implementations, the region 424 is not in fluid communication with the inner volume 136.

In a third open state (e.g., fully open), as schematically illustrated by FIGS. 4C and 5D, the poppet 320 is at a fully open position (e.g., the poppet 320 fully extended from the surface 410 with the spring 330 fully compressed). In certain implementations in which the valve 220 comprises a hydraulic brake 420, the region 424 has its smallest volume when the poppet 320 is at the fully open position.

During the compression phase of operation of the plasma compression system 100, the valves 220 are controllably actuated by the pressurized gas 305 to controllably apply the pressurized gas 305 to the liquid liner to compress the liquid liner inwardly (e.g., away from the outer wall 210 of the apparatus 130) onto the plasma within the center cavity of the inner volume 136. During a rebound phase of operation of the plasma compression system 100 after the compression phase, the compressed liquid liner expands outwardly (e.g., towards the outer wall 210 of the apparatus 130), the valves 220 are configured to allow the gas within the inner volume 136 (e.g., but not the liquid liner) to flow radially outwardly from the inner volume 136 back into the channel 216. For example, the mass of the poppet 320 can keep the poppet 320 open through the compression phase into the rebound phase, until the rebounding liquid liner material returns to the valve 220 and the hydrostatic pressure from the liquid liner (e.g., comprising a material with a higher mass density than the gas) assists in moving the poppet 320 back to the closed position. For example, the rebounding liquid liner material can impinge the second portion 324 of the poppet 320 via the one or more holes 426, applying a force on the poppet 320 in the same direction as the restoring force from the spring 330 and/or the centripetal force from the rotating motion, returning the poppet 320 to the closed position (e.g., shown in FIG. 5A).

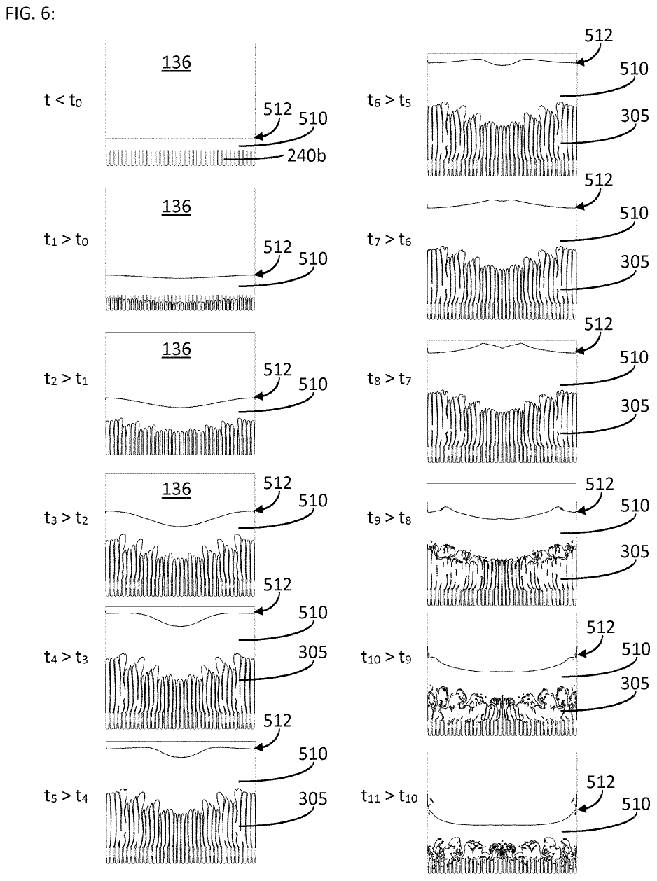

FIG. 6 is a sequence of simulation images schematically illustrating a cross-sectional view of the liquid liner 510 at various moments during the steady state phase, compression phase, and rebound phase in accordance with certain implementations described herein. The simulation images are oriented such that the outer wall 210 and the plurality of partitions 240 are at the bottom of each simulation image and the central cavity of the inner volume 136 in which the plasma is to be introduced is at the top of each simulation image.

During the steady state phase (e.g., before actuation of the valves 220 at time t₀), the liquid liner 510 is in solid body rotation (e.g., without any fluid shear) with the rotating apparatus 130, with minimal turbulence or cavity surface perturbation, such that the surface 512 of the liquid liner 510 facing the inner volume 136 is substantially cylindrical. Upon introduction of the pressurized gas 305 into the gap volume 116 and the channels 216 at time t₀, activation of the valves 220 that are adjacent to the endplates 230a,b (e.g., with lower predetermined threshold pressures) occurs before activation of the valves 220 closer to the center of the apparatus 130 (e.g., with higher predetermined threshold pressures). As a result of the pressurized gas 305 pushing directly on the liquid liner 510 at different pressures, flow rates, and/or times, the surface 512 of the liquid liner 510 facing the plasma becomes concave.

FIG. 6 shows the evolution of the surface 512 of the liquid liner 510 at sequential moments t₁, t₂, t₃, t₄, t₅, t₆, and t₇ during the compression phase in which the volume of the central cavity containing the plasma becomes smaller. Throughout the compression phase, the surface 512 facing the inner volume 136 remains substantially smooth (e.g., without substantial perturbations), while the portion of the liquid liner 510 in contact with the pressurized gas 305 has more structure and variations (e.g., with perturbations). FIG. 6 shows the evolution of the surface 512 of the liquid liner 510 at sequential moments t₈, t₉, t₁₀, and t₁₁ during the rebound phase in which the liquid liner 510 expands outwardly and the volume of the central cavity containing the plasma becomes larger. During this rebound phase, the pressurized gas 305 can be forced by the liquid liner 510 back through the valves 220 to be recaptured and reused. Throughout the rebound phase, the surface 512 facing the inner volume 136 remains somewhat smooth (e.g., without substantial perturbations), while the portion of the liquid liner 510 in contact with the pressurized gas 305 becomes highly chaotic (e.g., many substantial perturbations).

Certain implementations described herein controllably drive an array of liquid metal columns (e.g., the liquid medium within the regions 250) to achieve a substantially symmetric (e.g., spherical) collapse of the liquid liner, while reducing (e.g., avoiding) production of perturbations that are otherwise generated when liquids are driven with gas pressure.

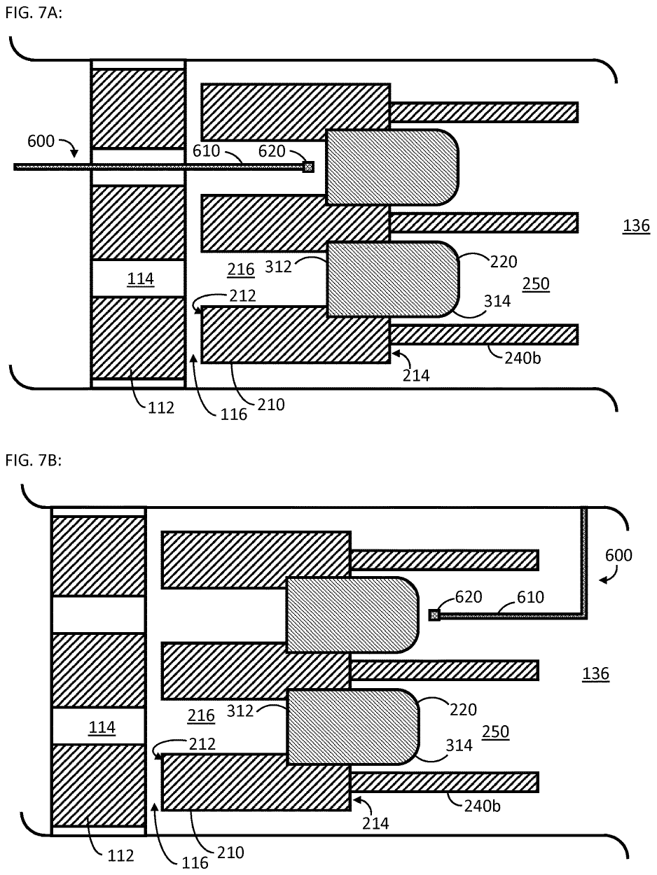

In certain implementations, the predetermined threshold pressures, flow rates, and/or the activation timings of the various valves 220 are configured to be controllably adjusted (e.g., tailored) to produce the shaped liquid liner compression. FIGS. 7A and 7B schematically illustrate cross-sectional views of two example tools 600 configured to controllably adjust a valve 220 affixed to the outer wall 210 in accordance with certain implementations described herein. Each controllably adjustable valve 220 can comprise a mechanism (e.g., adjustment nut; dashpot) that is accessible and mechanically adjustable by the tool 600 to change the dynamic activation (e.g., opening behavior) of the valve 220. For example, the mechanism can comprise at least one adjustment nut or screw configured to adjust the restoring force generated by the spring 330 or an open cross-sectional area of the at least one orifice 316 of the valve 220. For another example, the mechanism can comprise a bypass in a dashpot configured to adjust opening trajectory (e.g., timing) of the valve 220. The tool 600 can comprise at least one body 610 (e.g., shaft) and at least one head 620 (e.g., blade; socket) affixed to the at least one body 610, the at least one head 620 configured to adjust the mechanism of at least one valve 220.

As shown in FIG. 7A, the mechanism of certain implementations can be accessible from the first portion 312 of the casing 310 (e.g., via an opening through the first portion 312). The tool 600 of FIG. 7A can be inserted through an orifice extending through the outer wall 112 of the vessel 110 (e.g., through a port 114 or through another orifice dedicated to use by the tool 600) and through the gap volume 116 and the channel 216 to the first portion 312 of the valve 220. As shown in FIG. 7B, the mechanism of certain implementations can be accessible from the second portion 314 of the casing 310 (e.g., from the inner volume 136). The tool 600 of FIG. 7B can be inserted from above or below the apparatus 130, through the inner volume 136 and the region 250 to the second portion 314 of the valve 220.

In certain implementations, as shown in FIGS. 7A and 7B, the tool 600 comprises a single body 610 and single head 620 configured to adjust a single valve 220 at a time, while in certain other implementations, the tool 600 comprises multiple bodies 610 and multiple heads 620 configured to adjust multiple valves 220 at a time. For example, the tool 600 can comprise a body 610 and a head 620 for each valve 220 along an axial column of valves 220 (e.g., comprising 36 rows of valves 220). The tool 600 can be inserted and placed into contact with the valves 220 of a first axial column of valves 220, and after the adjustments are made, the tool 600 can be retracted from the first axial column of valves 220, the apparatus 130 can be rotated (e.g., indexed) such that a second axial column of valves 200 is accessible by the tool 600, and the second axial column of valves 220 can be adjusted. In this way, the tool 600 can sequentially adjust each axial column of valves 220 (e.g., about 200 axial columns) until all the valves 220 of the apparatus 130 are adjusted.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, apparatuses, components, or steps in a non-exclusive manner, indicating that the referenced elements, apparatuses, components, or steps may be present, or utilized, or combined with other elements, apparatuses, components, or steps that are not expressly referenced.

It is to be appreciated that the implementations disclosed herein are not mutually exclusive and may be combined with one another in various arrangements. In addition, although the disclosed methods and apparatuses have largely been described in the context of plasma compression systems, various implementations described herein can be incorporated in a variety of other suitable devices, methods, and contexts. More generally, as can be appreciated, certain implementations described herein can be used in a variety of contexts that can benefit from having a rotating apparatus as described herein. Specifically, the term “apparatus” and “element” are understood to have the same meaning and be interchangeable in this description.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of apparatuses labeled by ordinal adjectives (e.g., first, second, etc.), the ordinal adjective are used merely as labels to distinguish one apparatus from another (e.g., one signal from another or one circuit from one another), and the ordinal adjective is not used to denote an order of these apparatuses or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. An apparatus configured to be rotated within a vacuum vessel of a plasma compression system, the apparatus comprising:
a substantially cylindrical outer wall configured to rotate about a longitudinal symmetry axis, the outer wall comprising an outer surface, an inner surface at least partially bounding an inner volume of the apparatus, and a plurality of channels extending through the outer wall, the inner volume configured to contain a liquid medium; and
a plurality of valves affixed to the outer wall and in fluid communication with the plurality of channels, the plurality of valves configured to selectively control pressurized gas flow from outside the outer surface, through the plurality of channels, into the inner volume.

2. The apparatus of claim 1, further comprising:
first and second endplates at opposite ends of the outer wall; and
a plurality of partitions extending radially from the inner surface into the inner volume, the plurality of partitions at least partially bounding a plurality of regions within the inner volume between the first and second endplates, the plurality of regions in fluid communication with the plurality of valves.

3. The apparatus of claim 2, wherein a distance between the two endplates in a range of 1 meter to 10 meters, the outer surface has an outer radius in a range of 0.5 meter to 5 meters, the inner surface has an inner radius in a range of 0.5 meter to 5 meters, and the outer wall has a thickness in a range of 0.05 meter to 1 meter.

4. The apparatus of claim 2, wherein the first and second endplates are substantially annular and substantially perpendicular to and concentric with the longitudinal symmetry axis.

5. The apparatus of claim 2, wherein the plurality of partitions parse a portion of the inner volume at least partially bounded by the outer wall into a cellular structure.

6. The apparatus of claim 5, wherein the plurality of partitions comprises a plurality of axial partitions substantially parallel to and extending along the longitudinal symmetry axis and a plurality of azimuthal partitions substantially perpendicular to and extending around the longitudinal symmetry axis.

7. The apparatus of claim 6, wherein a region of the plurality of regions bounded by two axial partitions and two azimuthal partitions has a trapezoidal prism shape with a rectangular front face open to the inner volume and a rectangular rear face closed by the inner surface and in fluid communication with a corresponding valve of the plurality of valves.

8. The apparatus of claim 1, wherein the plurality of channels extend substantially perpendicularly relative to the longitudinal symmetry axis from the outer surface to the inner surface.

9. The apparatus of claim 1, wherein at least one valve of the plurality of valves comprises:
a casing having a first portion configured to be in fluid communication with a channel of the plurality of channels, a second portion configured to in fluid communication with the inner volume, and at least one orifice in fluid communication with the inner volume;
a poppet configured to move relative to the casing in response to pressurized gas from the channel having a gas pressure greater than a predetermined threshold value; and
a spring in mechanical communication with the poppet and the casing, the spring configured to apply a restoring force to the poppet in response to movement of the poppet relative to the casing.

10. The apparatus of claim 9, wherein the restoring force is controllably adjustable and different valves of the at least one valve have restoring forces that differ from one another such that the different valves are controllably activated at different moments during a pressurized gas pulse being applied to the plurality of channels.

11. The apparatus of claim 9, wherein the at least one valve has a plurality of operational states comprising:
a closed state in which the poppet is pressed against a surface of the casing by the spring, forming a seal; and
at least one open state in which pressurized gas can flow between the poppet and the surface and through the at least one orifice.

12. The apparatus of claim 11, wherein the at least one open state comprises:
a first open state in which a pressure of the pressurized gas within the channel is greater than the predetermined threshold pressure of the valve such that the pressurized gas moves the poppet and compresses the spring to crack open the seal, allowing the pressurized gas to begin flowing through the at least one orifice;
a second open state in which the poppet moves further to further compress the spring, allowing more of the pressurized gas to flow from the channel into the inner volume; and
a third open state in which the poppet is fully extended and the spring is fully compressed.

13. The apparatus of claim 9, wherein the valve comprises a hydraulic brake configured to reduce a speed of the poppet towards an end of a range of motion of the poppet.

14. A plasma compression system configured to receive and contain a plasma within a volume at least partially bounded by a circulating metallic liquid medium and to controllably compress the liquid medium around the plasma thereby reducing the volume and compressing the plasma, the system comprising:
a plasma containment vessel;
a plurality of pressurized gas sources fixedly attached to the vessel; and
an apparatus within the vessel, the apparatus configured to contain the metallic liquid medium within an inner volume at least partially bounded by the apparatus and to rotate within the vessel about a longitudinal symmetry axis of the apparatus, the apparatus comprising a plurality of valves configured to receive pressurized gas from the plurality of pressurized gas sources, the plurality of valves configured to be controllably actuated to apply the pressurized gas directly to the metallic liquid medium within the inner volume to compress the metallic liquid medium in a predetermined pattern.

15. The system of claim 14, wherein the plurality of valves are arranged in an array on an outer wall of the apparatus, the array comprising a plurality of axial columns of valves extending substantially parallel to the longitudinal symmetry axis of the apparatus and a plurality of azimuthal rows of valves extending substantially perpendicularly to the longitudinal symmetry axis.

16. The system of claim 14, wherein each valve of the plurality of valves has a plurality of operational states comprising:
a sealed state in which the valve prevents flow of the pressurized gas through the valve to the inner volume; and
at least one open state in which the valve allows flow of the pressurized gas through the valve to the inner volume, the at least one open state actuated by the pressurized gas having a pressure greater than a predetermined threshold pressure of the valve.

17. The system of claim 16, wherein the valves of a first azimuthal row of valves have first predetermined threshold pressures that are substantially equal to one another and the valves of a second azimuthal row of valves have second predetermined threshold pressures that are substantially equal to one another and that are not substantially equal to the first predetermined threshold pressures.

18. The system of claim 16, wherein each valve of the plurality of valves is in the sealed state during a steady state phase of operation of the system in which the liquid medium is in solid body rotation with the apparatus.

19. The system of claim 18, wherein each valve of the plurality of valves is in the at least one open state during a compression phase of operation of the system in which the pressurized gas compresses the liquid medium inwardly away from an outer wall of the apparatus.

20. The system of claim 19, wherein each valve of the plurality of valves is in the at least one open state during a rebound phase of operation of the system in which the liquid medium expands outwardly towards the outer wall.
